(19) United States
(12) Patent Application Publication
(10) Pub. No.: US 2010/0008850 A1
(43) Pub. Date: Jan. 14, 2010

(54) Method of generating hydrogen in drinking water using an enerceutical product added to magnesium in a hydrogen permeable but solute impermeable container

(76) Inventor: William John Martin, South Pasadena, CA (US)

Correspondence Address: William John Martin, 1634 Spruce Street, South Pasadena, CA, 91030, US

(21) Appl. No.: 12/218,451

(22) Filed: Jul. 14, 2008

(51) Int. Cl. C01B 3/00

(52) U.S. Cl. 423/657

(57) ABSTRACT

Consuming water with increased hydrogen content can provide clinical benefits to humans and animals through a non-mitochondria alternative cellular energy (ACE) pathway and also as an antioxidant. This application discloses that the hydrogen content of drinking water can be safely increased by placing into the water a hydrogen generating device, such as a mixture of metallic magnesium and EH-101 (HB-101) containing solution, whereby the device allows for the selective passage of the generated hydrogen but restricts the passage of magnesium and EH-101 (HB-101) components. This partitioning of hydrogen from EH-101 (HB-101) components is achieved by using either reverse osmosis membrane, low density plastic material such as polyvinylidene chloride (PVDC or Saran), or low molecular weight cutoff dialysis membrane to create a sealed container of the magnesium and magnesium chloride, that can be placed into drinkable water. The EH-101 (HB-101) can be initially placed into a breakable inner compartment within the hydrogen permeable container. This compartment can be easily broken by simple squeezing just prior to placing the device into the water that is intended to have its hydrogen content increased. The increased hydrogen content can be assessed by the capacity of the water to decolorize a potassium permanganate test sample.

### CROSS REFERENCE TO RELATED APPLICATIONS

Co-Pending Patent Application

Method of Generating Hydrogen and of Selectively Transferring the Generated Hydrogen to Drinking Water as a Potential Source of Alternative Cellular Energy (ACE). Submitted Jul. 8, 2008

Methods for Detection of Ultraviolet Light Reactive Alternative Cellular Energy Pigments (ACE-pigments) William John Martin Submitted Dec. 24, 2007

Method of Activating the Alternative Cellular Energy (ACE) Pathway in the Therapy of Herpes Virus Infections William John Martin and Sheila Calderon Submitted Dec. 26, 2007

Method of Assessing and of Activating the Alternative Cellular Energy (ACE) Pathway in the Therapy of Diseases. William John Martin Submitted Jan. 17, 2008

Enerceutical Mediated Activation of the Alternative Cellular Energy (ACE) Pathway in the Therapy of Diseases William John Martin Submitted May 8, 2008

Previously Submitted but Now Abandoned Patent Applications

Ser. No. 10/044,683. Therapy of stealth virus associated cancers and other conditions using light. William John Martin. (Abandoned)

Ser. No. 10/047,313. Therapy of stealth virus associated cancers and other conditions using medium chain triglycerides. William John Martin. (Abandoned)

Ser. No. 10/050,232. Diagnosing and monitoring the therapy of stealth virus infections based on the detection of auto-fluorescent material in hair. William John Martin. (Abandoned)

Ser. No. 10/058,480. Therapy of stealth virus associated cancers and other conditions using magnetic energy. William John Martin. (Abandoned)

Ser. No. 10/164,258 Energy supportive therapy of stealth virus associated diseases. William John Martin. (Abandoned)

Ser. No. 10/174,466 Sound therapy of stealth virus associated diseases. William John Martin. (Abandoned)

Ser. No. 10/192,936 ACE-Pigments and humic acids as energy sources. William John Martin. (Abandoned)

Submitted: Ser. No. 10/ Methods for Collection of Alternative Cellular Energy Pigments (ACE-pigments). William John Martin. (Abandoned)

Submitted: Ser. No. 10/ Methods for Elimination of Toxic Alternative Cellular Energy Pigments (ACE-pigments) and for Their Replacement Using Activated Humates, including Humic and Fulvic Acids. William John Martin. (Abandoned)

United States Patents (Awarded)

U.S. Pat. No. 5,985,546 Stealth virus detection in the chronic fatigue syndrome. William John Martin

U.S. Pat. No. 5,891,468 Stealth virus detection in the chronic fatigue syndrome. William John Martin

U.S. Pat. No. 5,753,488 Isolated stealth viruses and related vaccines. William John Martin

U.S. Pat. No. 5,703,221 Stealth virus nucleic acids and related methods. William John Martin

PCT (Patent Cooperation Treaty)

WO 92/20797 Stealth virus detection in the chronic fatigue syndrome. William John Martin

WO 99/34019 Stealth virus nucleic acids and related methods. William John Martin

WO 99/60101 Stealth viruses and related vaccines. William John Martin

### REFERENCES TO PUBLISHED ARTICLES

Alternative Cellular Energy Pigments (ACE-Pigments):
1 Martin W J. Alternative cellular energy pigments mistaken for parasitic skin infestations. Exp. Mol. Path 78: 212-214, 2005.
2 Martin W J. Alternative cellular energy pigments from bacteria of stealth virus infected individuals. Exp. Mol. Path 78: 217-217, 2005.
3 Martin W J. Progressive Medicine. Exp Mol Path 78: 218-220, 2005.
4 Martin W J, Stoneburner J. Symptomatic relief of herpetic skin lesions utilizing an energy based approach to healing. Exp. Mol. Path 78: 131-4, 2005.
5 Martin W J. Etheric Biology. Exp Mol Path 78: 221-227, 2005.
6 Martin W J. Stealth Virus Culture Pigments: A Potential Source of Cellular Energy. Exp. Mol. Pathol. 74: 210-223, 2003.
7 Martin W J. Complex intracellular inclusions in the brain of a child with a stealth virus encephalopathy. Exp. Mol. Pathol. 74: 179-209, 2003.
8 Martin W J. Photons and phonons: Theoretical aspects of biophysics and potential therapeutic applications. Proceeding of Neural Therapy Workshop on Sound and Light Therapy, Seattle, Wash., Feb. 21-23, 2003.

### STATEMENT REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not applicable.

### BACKGROUND OF THE INVENTION

The invention is based on the following broad conceptual understanding on how the body can acquire cellular energy other than through the oxidative metabolism of foods. Essentially, an alternative cellular energy (ACE) pathway has been identified that is mediated by the energy converting (transducing) properties of mineral containing complexes of organic molecules; arbitrarily termed alternative cellular energy pigments (ACE pigments) when derived from patients, and enerceuticals when derived from other sources. Cellular energy generated by this pathway can seemingly complement the chemical energy that is derived by living organisms from the metabolism of food. The ACE pathway is likely to contribute to various physiological functions of the body. Of particular relevance to public health programs, the ACE pathway is postulated to provide an auxiliary defense mechanism beyond that of the immunological system, such that an inadequacy of this pathway may limit the body's capacity to overcome various infectious diseases. The ACE pathway is also anticipated to be involved in the normal functioning of the brain since ACE pigments have been identified in brain tissue and appear to be transported within peripheral nerves. It is reasonable to presume that many illnesses, not necessarily of infectious origin, may place an added burden on the ACE pathway and that an inadequacy, deprivation or excessive demands on the ACE pathway may be a factor in delaying the normal disease recovery process. Conversely, augmentation or activation of an impaired ACE pathway may facilitate recovery from a wide range of illnesses. Moreover, a fully functioning ACE pathway is likely to be a factor in disease prevention, maintaining optimal wellness, enhancing athletic performance, increasing cognitive abilities, etc. The listed pending and awarded patents relating to the ACE pathway are incorporated herein by reference.

An important insight into the ACE pathway has come from observing reducing (electron donating) activity and gas bubble formation alongside ACE pigments suspended in water. A photograph showing gas formation was published in the article I wrote entitled “Alternative cellular energy pigments mistaken for parasitic skin infestations.” Exp. Mol. Path 78: 212-214, 2005. To experienced observers, the gas bubble shown in this paper has visual characteristics of hydrogen rather than oxygen. Note that hydrogen gas can form from molecular hydrogen, i.e., a hydrogen atom that retains its electron, or possibly even acquires a second electron (H⁻). Molecular hydrogen atoms can donate their electrons in reducing reactions and become H⁺ ions. Consistent with the concept that molecular hydrogen is directly involved in the ACE pathway is the additional finding of electron donating and occasional apparent hydrogen gas formation in various enerceutical products that can substitute for patient derived ACE pigments. I now believe that molecular hydrogen may, in fact, be part of the ACE pathway. Additional reasoning along these lines is as follows:

The energy embedded in photosynthesized compounds, such as carbohydrates, is mainly retrieved by eukaryotic cells through the process of oxidative phosphorylation occurring within mitochondria. This process comprises the formation of a hydrogen ion gradient that is used to drive the synthesis of adenosine triphosphate (ATP) via the enzyme ATP synthase. The hydrogen atoms derived from carbohydrates are captured and carried by nicotinamide adenine dinucleotide in the reaction “NAD⁺ plus 2H to yield NADH” which, in turn yields “NAD⁺ plus 2H⁺ plus 2 electrons (e⁻).” It is reasonable to suppose that prior to the availability of ATP synthase and NAD⁺ that the cell was able to directly use H atoms as an energy source.

Indeed in addition to published clinical studies, I have observed therapeutic benefits in patients consuming water with increased molecular hydrogen content. Other investigators have assumed that such benefits arise solely from antioxidant activity i.e. the capacity of molecular hydrogen to donate its electron to oxidizing toxic free radicals. To my knowledge, no other investigator has focused on the potential of hydrogen as a natural fuel source for the body. Whatever its mode of action, there is therapeutic value of water with an increased content of molecular hydrogen.

Hydrogen can be externally added to water, especially under pressure as a gas. More commonly, hydrogen is produced from the cathode in water electrolysis and in photoelectrolysis. Another approach has been to use magnesium particles mixed with ceramic particles and contained within a ceramic case. The water is said to be “pulverized by a discharge of electron and far-infrared ray effect of the ceramics.” This process may help activate the water and is also stated to result in hydrogen peroxide formation. (U.S. Pat. No. 7,189,330 Method of producing hydrogen rich water and hydrogen rich water generator)

Hydrogen production in water from magnesium is known to be greatly enhanced in the presence of hydrochloric acid. I have also observed marked hydrogen bubble formation from magnesium particles suspended in a Japanese product named HB-101 when used in farming and EH-101 when used as a dietary supplement in humans and animals (www.HB-101.com). This product is a mixed blend of steam extracted volatile materials primarily obtained from Japanese cedar (Crytomeria Japonica) and Hinoki cypress (Chamaecyparis Obtusaand); with additional steam extracted material from Japanese red pine (Pinus Densiflora) and Common Plantain (Plantago Major). I have performed gas chromatograph-mass spectroscopy (GC-MS) studies on this product. Minute quantities of twenty compounds were identified and were individually matched to known compounds. The matching revealed identity with,or at least very close similarity to 10 terpenoids, 2 terpenes, 5 phenolics, a phthalate, a fatty acid and a carbohydrate. The most abundant product matched very closely to 6,6-Dimethylbicyclo (3.1.1) heptane-2-methanol. The molecular weights (MW) of all of the products ranged from 124 to 354. Seven minerals are also present (Ca, Na, Mg, Si, Al, Fe and Sr) with an aggregate concentration of 44 parts per million (ppm) with Ca (25 ppm) and Na (10 ppm) being the two highest concentrations. An interesting observation is that when several magnesium particles are present, the bubbles from some particles tended to be drawn to other particles that become enveloped in numerous bubbles. Moreover, different particles would occasionally show an attraction force towards each other. I also noted that the bubbles tended to stay attached to these dominant particles even as the HB-101 fluid dries from evaporation.

HB-101 is widely used in Japanese agriculture and also in the Japanese fish markets. Interestingly, the recommended concentrations for use in agriculture is 1:1,000 to 1:10,000 dilutions in foliage spray and soil amendment. It is also added to the water used to make ice for helping to maintain freshness of packed fish. Humans are advised to take 1 ml of undiluted HB-101 daily. It seemed reasonable to suppose that one of the major actions of HB-101 is to assist plants, animals and humans to generate hydrogen from water, perhaps in concert with some of the organism's magnesium.

To make clinical use of this postulate, it is desirable to have a circumstance where the magnesium and the HB-101/EH-101, subsequently referred to as EH-101, can be maintained physically separable from any water that is intended for consumption or for use in agriculture. This can not be achieved with porous ceramic since the EH-101 would readily diffuse into the water. Some form of partitioning is needed to allow the passage of hydrogen, yet to restrict the passage of magnesium and chloride ions. The present application discloses such a method.

### BRIEF SUMMARY OF THE INVENTION

The invention describes a hydrogen generating mechanism that is coupled to a method of allowing the generated hydrogen to selectively pass into water that remains suitable for drinking. I initially confirmed the markedly enhanced production of hydrogen by simply placing small particles of metallic magnesium (hereinafter referred to as magnesium particles) into a drop of EH-101. The formation of hydrogen gas bubbles easily exceeds by a factor of 10 that produced by magnesium particles alone, but was still less than half of that achievable using hydrochloric acid. Magnesium particles plus EH-101 also increased the availability of molecular hydrogen, as opposed to the chemically inert hydrogen gas. This was shown by the capacity of the hydrogen enhanced water to rapidly decolorize a dilute solution of the oxidizing chemical, potassium permanganate (discussed below).

The actual role of the EH-101 is somewhat uncertain but presumably provides an energy stepping stone between magnesium and magnesium hydroxide in the reaction Mg+2H₂0→Mg(OH)₂+2H (Note 2H can, but does not necessarily form H₂ gas).

The next issue was to provide a method that allows hydrogen, which is generated in a reaction between magnesium particles and EH-101, to freely pass into water that is suitable for drinking. Hydrogen atoms can penetrate various types of barriers that are impermeable to many other compounds. Permeability is mainly on the basis of the small size of the hydrogen atom. The components of EH-101 are far larger than hydrogen and furthermore, they probably bond with water molecules. It is possible, therefore, to use materials that will allow the passage of molecular hydrogen or hydrogen gas, but be impermeable to the hydrogen generating components of HB-101. Such materials include various hydrogen permeable metals, such as niobium, vanadium, tantalum or their alloys, (http://www.rebresearch.com/H2perm2.htm). More economical and more conveniently available are several low density plastics (organic polymeric materials). For example, hydrogen gas permeability has been reported for polychlorotrifluoroethylene (PCTFE or Aclar®), polychlorotrifluoroethylene copolyethylene (PCTFFJPE or Halar®) and polyvinylidene chloride (PVDC or Saran®). Another grouping of hydrogen permeable (magnesium and components of EH-101 impermeable) materials is the membranes used for reverse osmosis of water. Reverse osmosis membrane, referred to hereinafter as R/O membrane, allows for the passage of water, which could potentially facilitate the transfer of dissolved molecular hydrogen atoms. R/O membranes vary in the amount of pressure needed to be applied to obtain optimal transfer of water. Low molecular weight cutoff dialysis membrane, e.g. 100 MW, can also partition EH-101 components from water. Such membranes are available from Spectrum Laboratory, Rancho Dominguez, Calif. For the present studies Saran wrap and low pressure R/O membrane were chosen to demonstrate the selective transfer of hydrogen, generated from the reaction of magnesium with EH-101, into water that remains magnesium and EH-101 free and is suitable for consumption.

The presence of hydrogen reducing activity in water can be easily assessed by the capacity of the water to decolorize the redox sensitive chemical potassium permanganate. This chemical is purple/red in oxidizing solutions (positive redox values) and becomes colorless when present in water with a negative redox value. At neutral pH the transition is at a slightly positive redox value. The speed of decolorization is an approximate measure of the negativity (reducing or electron donating capacity) of water. This simple method avoids the need for repeated calibration of an oxidation reduction potential (ORP) meter. The reaction is colored permanganate ions changing to colorless manganese oxide ions, according to the equation: MnO₄⁻+2H₂O+3e⁻→MnO₂+4OH⁻, E⁰=0.59 V

EH-101 was obtained from Y. K. Flora, Torrance, Calif. Magnesium particles are obtainable as fine, irregularly shaped shavings from major metal suppliers. Magnesium powders can also be obtained. Saran wrap is made by Johnson and Johnson. Low pressure R/O membrane (ACM4) was obtained from Trisep Corporation, Goleta, Calif. A wide range od dialysis membranes are also available from commercial suppliers. Most are made from cellulose and have specified cutoff values as low as 100 MW.

In one embodiment, the Saran wrap and the R/O membrane can be used in the form of a sealed tea bag like container that is simply placed into the water that is intended to be consumed. Since the EH-101 is in a liquid form, it can be kept separated from the magnesium particles before use by simply placing the liquid within an easily breakable pouch within the tea bag like structure. Alternatively one can construct a Saran wrap or R/O membrane container with an opening, such as a screw cap. This will allow filling with the liquid just prior to use. A fillible low molecular weight dialysis device can also be employed. Water can also be bulk treated using any of the disclosed methods prior to bottling for human consumption or prior to storage in tanks for both animal consumption and agricultural use.

In the disclosed embodiment, it was possible to provide hydrogen enhanced water that readily decolorized potassium permanganate, was unaltered in its pH and was devoid of any testable EH-101. Note EH-101 has a strong pine taste when consumed.

### BRIEF DESCRIPTION OF THE DRAWINGS

Not Applicable and none included

### DETAILED DESCRIPTION OF THE INVENTION

In a specific embodiment, both low pressure R/O membrane (ACM4), and Saran wrap were folded into a tubular shape containers and the bottom opening and the side edges tightly sealed with adhesive tape, leaving a small opening at the top. Approximately 1 gram of magnesium particles was introduced into the column space surrounded by either the R/O membrane or Saran wrap. The inner space was then filled with 1 ml of EH-101. Any residual air was removed by gently squeezing the membrane and the remaining opening on the constructed bag was folded and tightly sealed. Note heat can also be used for sealing the ends and sides of the constructed containers. Care was taken not to allow any tears in the Saran wrap from the magnesium shavings, a problem less likely to be encountered using magnesium powder.

Individual membrane bags were placed in jars filled with approximately 100 ml of regular tap water. A lid was placed onto each of the jars. Control jars contained either tap water alone or tap water to which empty Saran wrap or R/O membrane bags, or bags containing either magnesium particles or EH-101, but not both, were added. At differing times, water samples were removed from the jars and added to equal volumes of a discernibly red solution of potassium permanganate. Easily observed decolorizing capacity of the tap water in contact with the Saran wrap and the R/O membrane bags that contained both magnesium particles and EH-101 developed within ten minutes of placing the bag into the tap water. This capacity increased over the next 30 minutes, during which time actual gas bubbles (presumably hydrogen) appeared within the test jars, especially those with the Saran wrap. The pH of all of the water samples remained essentially unchanged at around 6.5.

Water samples were also tasted to determine if any discernible EH-101 had penetrated the bag and entered into the water. In only one experiment was their a slight hint of EH-101 and this was attributed to incomplete sealing of the device. As a final demonstration, drops of a concentrated solution of potassium permanganate solution were added to the water in the various jars. Water in the test jars, but not the control jars, immediately decolorized the added drops of potassium permanganate. In the control jars, the drops could still be seen for several minutes as they slowly mixed with the water leading to an overall pinkish color of the water in these jars.

The above experiments confirmed the use of magnesium in the presence of EH-101 to generate hydrogen and for the ability of the hydrogen to be delivered to drinkable water in the absence of any transfer of appreciable amounts of EH-101 by using containers made from Saran wrap or R/O membrane. This method achieves the purpose of providing a simple method for enriching water with hydrogen. Such water is believed to assist in enhancing the ACE pathway for the therapy of diseases, and for the promotion of overall vitality in humans, animals and plants.

It can be assumed that many additional products, including some of those that I have termed enerceuticals, will have hydrogen generating activity in the presence of certain minerals, such as magnesium. Note that the term enerceuticals was coined to describe products with i) vitality enhancing activities in plants animals and humans, ii) potential therapeutic value for a wide range of illnesses, unlike pharmaceuticals that are generally designed to treat a restricted grouping of illnesses, or even only a specific disease and iii) did not necessarily have to localize to the site of disease pathology but could indirectly achieve their effect by creating an energy field that provided a biological effect beyond the actual presence of the enerceutical.

EH-101 is superior in terms of hydrogen gas formation than the other enerceuticals products so far tested and to polar (water insoluble) terpenes (essential oils) so far tested. The EH-101 product is at least as effective as most of the magnesium chloride products tested. Combinations of products may well show synergistic effects.

The presumed action of terpenes/terpenoids/phenolics from plants as stimulators of mineral catalyzed splitting of water is an entirely new field of chemistry as well as of biology. Realization of the potential of this pathway can help explain the source of energy for deciduous trees in early spring prior to new growth of leaves capable of photosynthesis. It can also help explain the apparent energy consumption by humans and animals that is well beyond the estimated calories made available from the intake of food.

In summary, water enriched with molecular hydrogen is known to have potential therapeutic value. Means of forming hydrogen enriched water for drinking or intravenous administration such drinking water, without adding potential contaminants to the water are desirable. Materials, such as EH-101 disclosed in this invention, can react with metals, such as magnesium, to generate molecular hydrogen. The generated hydrogen can be selectively added to water using the disclosed methods. The same approach can be used to add hydrogen to other fluids, such as gasoline, which will presumably add to the combustion power of the fuel. Such experiments are currently underway.

The principles, preferred embodiments and modes of operation of the present invention have been described in the foregoing specification. The invention which is intended to be protected herein, however, is not to be construed as limited to the sole use of Saran wrap or R/O membrane as the method for allowing selective passage of the generated hydrogen into water. Many other membranes will be found to be suitable for this purpose. In particular low cutoff regular dialysis membrane, e.g. from Spectrum Laboratories, Rancho Dominguez, Calif. provides membranes with 100 MW cutoff. Nor is the method restricted to only using magnesium plus EH-101 as the means of generating hydrogen. Various alloys of magnesium can show similar hydrogen producing activity as magnesium as can other alloys of various minerals, e.g. certain alloys of aluminum. The combination of magnesium and EH-101 containing solutions is particularly attractive, however, since it extends and helps explain the clinical observations regarding the health benefits of EH-101 in humans and comparable benefits to plants sprayed with water containing HB-101.

Additional embodiments and modifications will readily occur to those skilled in the art and especially upon practicing the currently described methods. Variations and changes may be made without departing from the spirit of the invention encompassed by the appended claims.

What I claim as my invention is:

1. A method for increasing the hydrogen content of water by reacting magnesium particles with EH-101 solution within a closed container that is placed into the water; the said container comprising a material that allows for the selective passage of hydrogen into the water, while preventing magnesium or the EH-101 components present within the container from entering into the water.

2. The method of claim 1 in which the container is constructed from a membrane suitable for the reverse osmosis of water because of its ability to block the passage of EH-101 components while allowing for the passage of hydrogen.

3. The method of claim 1 in which the container is constructed from a low density plastic membrane, such as polyvinylidene chloride (PVDC or Saran wrap) that has the ability to block the passage of EH-101 components while allowing for the passage of hydrogen.

4. The method of claim 1 in which the container is constructed from a low molecular weight cutoff dialysis membrane that has the ability to block the passage of EH-101 components while allowing for the passage of hydrogen.

5. The method of claim 1 in which the solution used to generate hydrogen in the presence of magnesium particles is HB-101, rather than EH-101.

6. The method of claim 1 in which the solution used to generate hydrogen in the presence of magnesium particles comprises other organic compounds within the chemical categories of terpenes, terpenoids and phenolics, as derived from plants.

7. The method of claim 1 in which the EH-101 is packaged into a breakable inner compartment within the hydrogen permeable container, such that the inner compartment maintains separation of the EH-101 from the magnesium particles until the inner compartment is broken by squeezing, which is performed just prior to placing the hydrogen permeable container into the water.

8. The method of claim 1 in which the magnesium particles are in the form of metal shavings

9. The method of claim 1 in which the magnesium particles are in the form of a metallic powder.
